(19) United States
(12) Patent Application Publication
(10) Pub. No.: US 2008/0094466 A1
(43) Pub. Date: Apr. 24, 2008

(54) Target use video limit notification on wireless communication device

(76) Inventor: Richard Eric Helvick, Portland, OR (US)

Correspondence Address: SHARP LABORATORIES OF AMERICA, INC., 1320 PEARL ST., SUITE 228, BOULDER, CO, 80302, US

(21) Appl. No.: 11/583,230

(22) Filed: Oct. 18, 2006

(51) Int. Cl. H04N 7/14

(52) U.S. Cl. 348/14.01

(57) ABSTRACT

A method and system for informing a user of a wireless communication device about conformance of a video sequence captured by the user with a target use for the video sequence. In one aspect, a wireless communication device comprises a video capture system, a user interface and a processor communicatively coupled with the video capture system and the user interface, wherein under control of the processor a video sequence captured by the video capture system is rendered on a display of the user interface while information on conformance of the video sequence with at least one target use for the video sequence is rendered on the display. Target use limit markers and advisory screen events rendered on the display allow the user who is shooting the video sequence to better budget the time afforded by the target use.

### BACKGROUND OF THE INVENTION

This invention relates to recording video sequences on mobile electronic devices and, more particularly, a method and system for facilitating a user's ability to conform the length of a video sequence recorded on a wireless communication device to a target use for the video sequence.

Wireless communication devices, such as mobile phones, pocket PCs and personal data assistants, often have a video capture system with capability to record short video sequences. These captured video sequences can be stored, transported and played-back in many different ways. For example, they can be stored on a local memory of the device and played-back on the device. They can be stored on a removable memory card inserted in the device and played-back on the device or transported and played-back on another device that receives the removable memory card. They can be stored on a local memory of the device and transported via a wired connection to another local device for playback. Or they can be stored on a local memory of the device and transported via a wireless connection to a remote device for playback.

Each of these target uses may have a different limit length for video sequences. Limit lengths may be inherent in or imposed upon the recording device, the playback device and the mode through which a video sequence is transported between such devices. For example, a local memory of a device may have a first limit length for a stored video sequence, a removable memory card may have a second limit length for a stored video sequence, and a transportation mode between devices may have a third limit length for a transported video sequence. With regard to the latter type of limit, one popular service for transporting a video sequence over a cellular telephone network is Multimedia Messaging Service (MMS). Operators of cellular networks that support MMS commonly impose a limit, such as 100 kilobytes, on the size of the MMS message that is used to carry a video sequence.

Despite these limit lengths, conventional wireless communication devices are not known to notify a user of how long a video sequence can be without exceeding a limit length associated with a target use, with the result that captured video sequences often violate limit lengths unbeknownst to the user. Such over-limit video sequences may be truncated such that the end of the video sequence is not viewable upon playback, and in some cases may be unable to be played-back at all.

### SUMMARY OF THE INVENTION

The present invention, in a basic feature, provides a method and system for informing a user of a wireless communication device about conformance of a video sequence captured by the user with a target use for the video sequence.

In one aspect, a wireless communication device comprises a video capture system, a user interface and a processor communicatively coupled with the video capture system and the user interface, wherein under control of the processor a video sequence captured by the video capture system is rendered on a display of the user interface while information on conformance of the video sequence with at least one target use for the video sequence is rendered on the display.

In another aspect, A method for providing to a user of a wireless communication device information on conformance of a video sequence captured by the user of the device with a target use for the video sequence comprises rendering on a display of the device a video sequence being captured and rendering simultaneously on the display information on conformance of the video sequence with at least one target use for the video sequence.

The conformance information may comprise at least one of a representation of a current length of the video sequence and a representation of a limit length of the target use of the video sequence, a first screen event rendered upon approach of a limit length of the target use of the video sequence and a second screen event rendered upon exceeding a limit length of the target use of the video sequence. The limit length may be a data limit or a time limit. The representations of the current length and the limit length may be in a progress bar format.

The target use may comprise playback from a local memory on the device, playback from a removable memory card, playback on a local device after offload of the video sequence from the device via a wired interface and playback on a remote device after offload of the video sequence from the device via a wireless interface. Where the target use comprises playback on a remote device, the video sequence may be offloaded from the device on a wireless interface in an MMS message.

At least one of the video sequence and the conformance information may be rendered in near real-time.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a wireless communication device in one embodiment of the invention.

FIG. 2 shows a local memory of a wireless communication device in one embodiment of the invention.

FIG. 3 shows an exemplary table within progress bar settings of a wireless communication device in one embodiment of the invention.

FIG. 4 shows an exemplary screen on a display of a wireless communication device in one embodiment of the invention.

FIG. 5 is a flow diagram of a method performed by a wireless communication device in one embodiment of the invention.

### DETAILED DESCRIPTION OF A PREFERRED EMBODIMENT

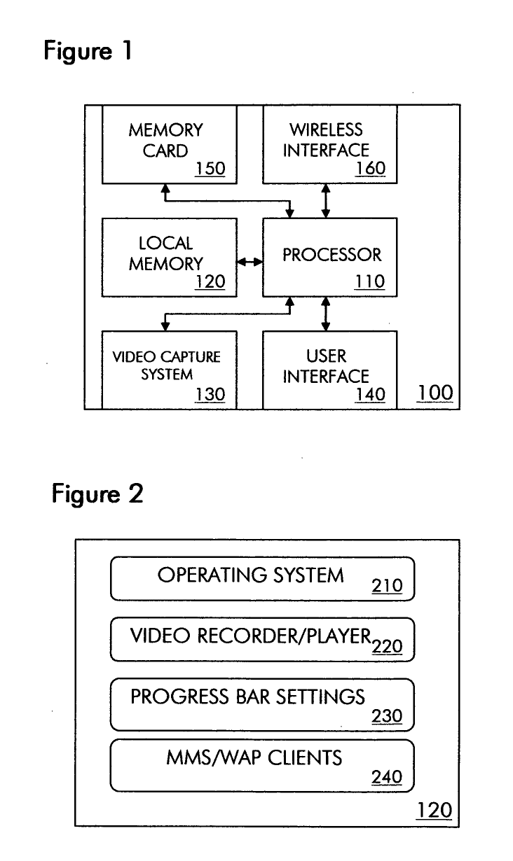

In FIG. 1, a wireless communication device 100 is shown in one embodiment of the invention. Device 100 may be, for example, a cellular phone, an Internet Protocol (IP) phone, or a pocket PC or personal data assistant (PDA) with wireless network connectivity. Device 100 includes a processor 110 communicatively coupled between a video capture system 130, a user interface 140, a removable memory card 150 and a wireless interface 160. Processor 110 is adapted to execute device software stored in local memory 120 and interoperate with elements 130, 140, 150 and 160 to perform various features and functions supported by device 100.

Video capture system 130 includes a video camera adapted, under control of processor 110, to capture video sequences. In some embodiments, video capture system 130 further includes a microphone adapted, under control of processor 110, to capture audio sequences that accompany the video sequences. It should be appreciated that video sequences discussed herein may include accompanying audio sequences even where not separately mentioned.

User interface 140 includes a display adapted, under control of processor 110, to render video sequences being captured by video capture system 130 in near real-time. The display is also adapted, under control of processor 110, to render near real-time information on conformance of video sequences with target uses for the video sequences. The display may be a liquid crystal display (LCD), for example. User interface 140 also includes a keypad adapted to receive user inputs. The keypad may be a standard 12-key telephonic keypad supplemented with soft keys, for example.

Memory card 150 is a storage element that is readily attachable and detachable from device 100 and is adapted to store in digital form, under control of processor 110, data received or generated on device 100, such as video sequences captured by video capture system 130. Device 100 has a slot with a communication interface adapted to receive and communicatively couple with memory card 150.

Wireless interface 160 is a network interface adapted to provide wireless connectivity between device 100 and remote devices reachable via network access points with which device 100 has established an over-air link. In some embodiments, wireless interface 160 is a cellular interface that establishes over-air cellular links with cellular base stations. In other embodiments, wireless interface 160 may be an 802.11-compliant LAN interface that establishes over-air LAN links with an 802.11 access points.

In some embodiments, device 100 further includes a wired interface adapted to provide wired connectivity between device 100 and local devices.

Turning to FIG. 2, local memory 120 is shown in more detail to include operating system 210, video recorder/player 220, progress bar settings 230 and Multimedia Messaging Service/Wireless Application Protocol (MMS/WAP) clients 240. In some embodiments, local memory 120 is a flash memory. Operating system 210 has instructions adapted for execution by processor 110 to manage and execute software programs that perform various features and functions supported by device 100. Video recorder/player 220 includes one or more software programs having instructions executable by processor 110 to facilitate capturing of video sequences by video capture system 130 and rendering of video sequences on a display of user interface 140. Video recorder/player 220 also invokes progress bar settings 230 to facilitate rendering of information on conformance of video sequences with target uses for such video sequences. Progress bar settings 230 include settings that specify, for targets uses of video sequences, corresponding limit lengths. In some embodiments, the limit lengths of settings 230 are expressed in maximum time lengths for video sequences, for example, in seconds. In other embodiments, the length limits of settings 230 are expressed in maximum data lengths for video sequences, for example, in kilobytes. MMS/WAP clients 240 include software programs adapted to support the client functions of MMS and WAP for transmitting video sequences to remote devices via wireless interface 160 using MMS as the messaging technology and WAP as the transport technology.

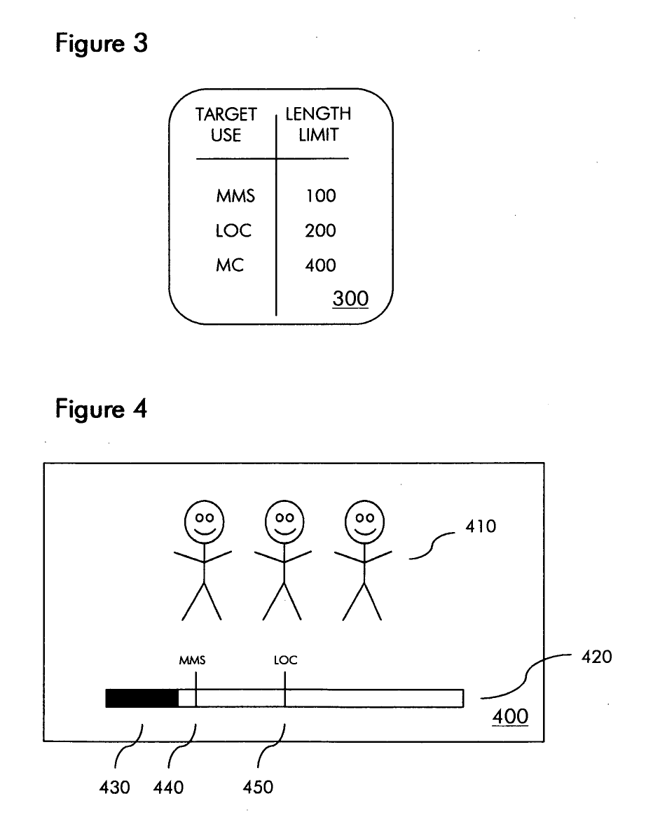

Turning now to FIG. 3, an exemplary settings table 300 within progress bar settings 230 is shown. Each entry in table 300 includes an identifier of a target use for a video sequence and a data limit in kilobytes. The first entry is <MMS, 100>. This entry reflects that where the target use is playback on a remote device after offloading a video sequence from device 100 on wireless interface 160 in an MMS message, the video sequence may be up to 100 kB long without violating the limit length of this target use. The limit length of this target use relates to the maximum size of an MMS message. For example, a network operator may impose a maximum size for an MMS message of 100 kB. MMS/WAP clients 240 may enforce the 100 kB length limit by truncating or refusing to offload video sequences that exceed 100 kB. The second entry is <LOC, 200>. This entry reflects that where the target use is playback from local memory 120, the video sequence may be up to 200 kB long without violating the limit length of this target use. The limit length of this target use relates to the amount of memory available within local memory 120 for storing video sequences. For example, the amount of available memory within local memory 120 may be 200 kB. The third entry is <MC, 400>. This entry reflects that where the target use is playback from memory card 150, the video sequence may be up to 400 kB long without violating the length limit of this target use. The length limit of this target use relates to the amount of memory available on memory card 150 for storing video sequences. For example, the amount of available memory on memory card 150 may be 400 kB.

Naturally, the settings described above are merely exemplary; there may be entries for various target uses having various limit lengths. For example, in some embodiments there may be an entry for playback on a local device after offload of the video sequence from device 100 via a wired interface. Moreover, in some embodiments, limit lengths may be expressed as time lengths rather than data lengths. However, it will be appreciated that time lengths will generally not have a fixed correspondence with particular data lengths due to a general dependence of the quantity of data produced on the amount of change in the image being recorded.

Progress bar settings 230 may be originally configured by the manufacturer of device 100 and may be updated by a user of device 100 through inputs made on the keypad of user interface 140, for example. In some embodiments, settings 230 may be automatically updated to reflect changes in limit lengths resulting from transient conditions, such as temporary changes in the amount of memory on local memory 120 or memory card 150 that is currently available for storing video sequences.

Turning now to FIG. 4, an exemplary screen 410 on a display 400 of user interface 140 is shown in one embodiment of the invention. Screen 410 is rendered substantially contemporaneously with the capture of a video sequence by video capture system 130, that is to say, in near real-time. Screen 410 renders the near real-time video sequence while rendering simultaneously near real-time information on conformance of the video sequence with target uses for the video sequence.

In the example shown, conformance information is shown for two target uses. The first target use is remote playback of the video sequence after offload via wireless interface 160 in an MMS message. The second is local playback of the video sequence from local memory 120. The conformance information includes a progress bar 420 having a current length indicator 430 showing the current length of the video sequence relative to MMS limit marker 440 and LOC limit marker 450, which are associated with limit lengths for the remote playback target use and the local playback target use, respectively. Limit markers 440, 450 are rendered at fractional distances along progress bar 420 in accordance with limit lengths retrieved by video recorder/player 220 from progress bar settings 230 that fall within the maximum video sequence capture length supported by device 100. For example, in the example shown, the maximum video sequence capture length supported by device is 400 kB such that progress bar 420 is 400 kB long; the limit length for remote playback of the video sequence after offload in an MMS message is 100 kB such that MMS limit marker 440 is displayed at the one-quarter mark of progress bar 420; and the limit length for local playback of the video sequence from local memory 120 is 200 kB such that LOC limit marker 450 is displayed at the one-half mark of progress bar 420.

In operation, as the user shoots the video sequence, current length indicator 430 traverses progress bar 420 from left to right, approaching and eventually exceeding limit markers 440, 450 en route to the right end of progress bar 420. As limit markers 440, 450 are approached and surpassed by current length indicator 430, advisory screen events are issued to the user. In some embodiments, as each one of limit markers 440, 450 is approached, a text message is rendered on screen 410 warning the user that he or she is about to reach the limit length for the target use associated with the one of the limit markers 440, 450. And as each one of the limit markers 440, 450 is surpassed, a text message is rendered on screen 410 notifying the user that he or she has exceeded the limit length for the target use associated with the one of the limit markers 440, 450. In some embodiments, in addition to or in lieu of text messages, color changes in current length indicator 430 may be used to advise the user of current status of the video sequence relative to limit lengths.

It will be appreciated that the limit markers and the advisory screen events allow the user who is shooting the video sequence to better budget the time afforded by the target use for the video sequence.

A warning screen event may be issued when current length indicator 430 is a number of kilobytes away from each one of limit markers 440, 450. In some embodiments, the number of kilobytes may be configured in progress bar settings 230.

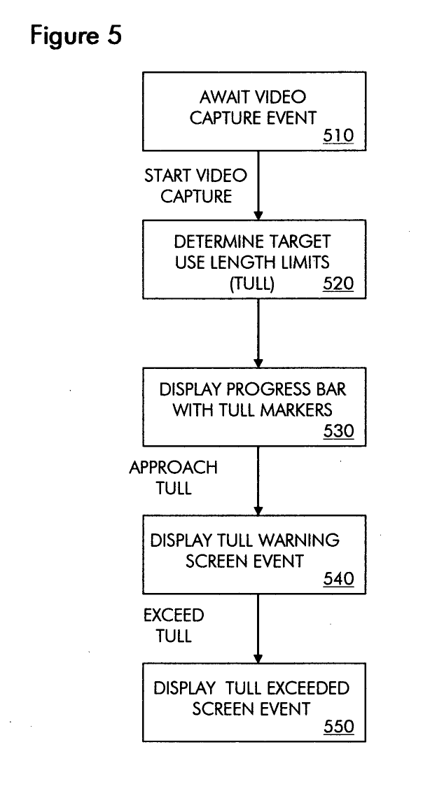

Turning now to FIG. 5, a flow diagram of a method performed by device 100 in one embodiment of the invention is shown. The steps described are performed or facilitated by video recorder/player 220 running on processor 110 and interfacing with video capture system 130, user interface 140 and progress bar settings 230. The flow begins with device 100 awaiting the start of capture of a video sequence (510). Once the video sequence begins to be captured, device 100 determines operative target use length limits (TULL) for video sequences (520) through consultation of progress bar settings 230. Once the operative TULL have been determined, device 100 renders on display 400 in near real-time the video sequence being captured while rendering simultaneously a near real-time progress bar having a current length and one or more TULL markers determined from the operative TULL (530). The flow then proceeds with device 100 awaiting the approach by the current length indicator of a TULL. Once a TULL is about to be reached, device 100 renders a TULL warning screen event on display 400 (540). Device 100 then awaits the surpassing of the TULL. Once a TULL is surpassed, device 100 renders a TULL exceeded screen event (550). Naturally, if there is more than one operative TULL, Steps 540 and 550 are repeated.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A wireless communication device, comprising:
a video capture system;
a user interface having a display; and
a processor communicatively coupled with the video capture system and the user interface, wherein under control of the processor a video sequence captured by the video capture system is rendered on the display while information on conformance of the video sequence with at least one target use for the video sequence is rendered on the display.

2. The device of claim 1 wherein the conformance information comprises a representation of a current length of the video sequence and a representation of a limit length of the target use.

3. The device of claim 2 wherein the representation of the current length and the representation of the limit length are rendered in a progress bar format.

4. The device of claim 1 wherein the conformance information comprises a screen event rendered upon approaching a limit length of the target use.

5. The device of claim 1 wherein the conformance information comprises a screen event rendered upon surpassing a limit length of the target use.

6. The device of claim 1 wherein the target use comprises offload of the video sequence via a wireless interface of the device in a multimedia message type having a limit data length.

7. The device of claim 1 wherein the video sequence is rendered in near real-time.

8. The device of claim 1 wherein the conformance information is rendered in near real-time.

9. The device of claim 2 wherein the limit length is a time length.

10. The device of claim 2 wherein the limit length is a data length.

11. A method for providing to a user of a wireless communication device information on conformance of a video sequence captured by the user of the device with a target use for the video sequence, comprising:
rendering on a display of the device a video sequence being captured; and
rendering simultaneously on the display information on conformance of the video sequence with at least one target use for the video sequence.

12. The method of claim 11 wherein the conformance information comprises a representation of a current length of the video sequence and a representation of a limit length of the target use.

13. The method of claim 12 wherein the representation of the current length and the representation of the limit length are rendered in a progress bar format.

14. The method of claim 11 wherein the conformance information comprises a screen event rendered upon approaching a limit length of the target use.

15. The method of claim 11 wherein the conformance information comprises a screen event rendered upon surpassing a limit length of the target use.

16. The method of claim 11 wherein the target use comprises offload of the video sequence via a wireless interface of the device in a multimedia message type having a limit data length.

17. The method of claim 11 wherein the video sequence is rendered in near real-time.

18. The method of claim 11 wherein the conformance information is rendered in near real-time.

19. The method of claim 12 wherein the limit length is a time length.

20. The method of claim 12 wherein the limit length is a data length.
